(19) United States
(12) Patent Application Publication
(10) Pub. No.: US 2004/0098382 A1
(43) Pub. Date: May 20, 2004

(54) Method and system for processing engineering change orders

(76) Inventors: Yuh-Ying Chuang, Taipei (TW); Li-Hua Lee, Taipei (TW); Kuang-Yu Peng, Taipei (TW)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 10/396,965

(22) Filed: Mar. 24, 2003

(30) Foreign Application Priority Data
Nov. 14, 2002 (TW) 91133332

(51) Int. Cl. G06F 7/00

(52) U.S. Cl. 707/3

(57) ABSTRACT

A method and a system for processing engineering change orders are provided. An electronic document generation module searches engineering change order data from a database according to search conditions entered by a user via a network terminal device and accordingly generates an engineering change order in the form of an electronic document file. An access authorization module finds associated responsible departments and access rights thereof from the database corresponding to the engineering change order. Then, an electronic document transfer module transfers the engineering change order to the responsible departments where data of the engineering change order are processed according to the access rights of the responsible departments and receives the processed data of the engineering change order from the responsible departments. Finally, a time-bound control module controls and monitors working efficiency of the responsible departments for data processing during transferring the engineering change order via the electronic document transfer module.

### FIELD OF THE INVENTION

The present invention relates to methods and systems for processing engineering change orders, and more particularly, to a method and a system for processing engineering change data through the use of an electronic data processing system.

### BACKGROUND OF THE INVENTION

The arrival of the information technology era has accompanied with a ubiquitous utilization of computer devices for aiding engineers, in the process of product design, development, even fabrication, to perform the jobs of product design and fabrication. This is the so-called Computer Aided Design (CAD) and Computer Aided Manufacturing (CAM). Based on the computer-aided tools already equipped in an enterprise, the CAD software and the CAM software described above have already upgraded from a former 2D system to a 3D system. In another aspect, the engineers or the fabrication departments, who are in charge of the product design, fabrication and analysis, has evolved from individual works to an integrated development. For this reason, in order to prevent each engineering department from becoming an information island, the information integration between engineering departments has become an important topic for internationally simultaneous engineering development.

In the absence of a systematic data administration, since the related engineering key data may be stored in a variety of different database systems and the data flow may be very complicated, the first problem to face is the complexity of data searching. In particular, when one database system has retrieved some data from some other database system, the original data stored in one database system will be changed, and thus, it is very unlikely to guarantee the consistencies between the data in each database system. For those engineers who need to use the stored data to perform product design, development, fabrication, even customer service, if the data they use are not consistent with each other, it would have a severe negative effect on product fabrication and customer service.

In the aspect of the engineering design change, a product of consumer electronics may include hundreds or thousands of component parts. In the beginning of such engineering design, a bill of required materials, i.e. the Bill of Material (BOM), for producing a product is often listed by an R&D or design engineers. The content of the BOM includes at least the name, the material number, the quantity and the specification of each of the required component part of the product. However, changes of the content of the BOM is often necessary due to the shortage of component parts in stock, the performance of the component parts or the cost of the component parts. Once the change of the BOM is necessary, i.e. an engineering design change, it must be approved by the related engineering design departments. Otherwise, disagreements between engineering design departments will be raised providing that the change is approved by only a portion, but not all, of the design engineers or the department managers, or at least not in a timely manner, the production efficiency and the quality of the product are thus affected.

The more important point is the works to be implemented by the related departments or engineers after the generation of an Engineering Change Order (ECO). The related departments and engineers may include the Engineering Change Order Coordinator, the departments of the Process Engineering, Material/Product Control, Quality Engineering, Testing Engineering, Product Engineering and Component Engineering, and the engineers thereof. According to each of the department and engineer listed above, once the engineering design needs to be changed, an innumerable amount of factors may be related to the product manufacturing. Once the information is not made consistent for each of the related departments and engineers in its shortest possible time, the later error finding and data changing may require a lot of unnecessary efforts. Even worse, the errors and the problems can still not be completed corrected and solved. Therefore, it is an imperative issue to provide a method and a system for processing the workflow of the related departments and engineers after an Engineering Change Order is generated.

### SUMMARY OF THE INVENTION

In order to solve the drawbacks of the prior art, a primary objective of the present invention is to provide a method and a system for processing engineering change orders, whereby the engineering change orders are processed automatically by an electronic data processing system via a network communication system.

Another objective of the present invention is to provide a method and a system for processing engineering change orders, whereby a user access is authorized during the implementation of the processing flow of engineering change orders on an electronic data processing system through a network communication system.

A further objective of the present invention is to provide a method and a system for processing engineering change orders, wherein the time-bound is controlled and monitored during the implementation of the processing flow of engineering change orders on an electronic data processing system through a network communication system.

In order to achieve the purposes described above, the system for processing engineering change orders according to the present invention includes a database, an electronic document generation module, a access authorization module, an electronic document transfer module, and a time-bound control module. Said database stores the engineering change order data, the BOM data, the electronic document data, the engineering change order processing personnel and department data, the access authorization data and the time-bound data. Said electronic document generation module finds the corresponding electronic document data from said database based on the searching criteria entered by a user on an electronic data processing system, and generates accordingly an electronic document frame on the electronic data processing system. Said access authorization module finds the corresponding access authorization content data from said database based on the engineering change order processing personnel and department data. Said electronic document transfer module transfers the electronic document found in said database that is matching the engineering change order processing personnel and department data of the electronic document data. Said time-bound control module implements a time-bound control based on the predetermined time-bound of an operation flow while said electronic document transfer module is the process of sending an electronic document.

The method of processing engineering change orders on the engineering change order processing system is the following. First, said electronic document generation module finds engineering change order data from said database based on the searching criteria entered on an electronic data processing system, and generates accordingly an engineering change order electronic document file. Then, said access authorization module finds the corresponding access authorization content from said database based on the department and the access limits of the owner of the engineering change order. Next, said electronic document transfer module transfers the engineering change order based on the content of the engineering change order and the access authorization. Finally, said time-bound control module controls and monitors the process time-bound of the engineering change order owner while said electronic document transfer module transfers the engineering change order.

In contrast to the conventional method and system for processing engineering change orders, the method and the system for processing engineering change orders of the present invention may automatically implement the processing flow of the engineering change orders on an electronic data processing system through a network communication system. And, the present invention may authorize the user access limits during the processing flow of an engineering change order. In addition, the present invention may also monitor and control the time-bound during the processing flow of the engineering change order.

### BRIEF DESCRIPTION OF THE DRAWINGS

The present invention can be more fully understood by reading the following detailed description of the preferred embodiments, with reference made to the accompanying drawings, wherein:

FIG. 1 is a block diagram showing application structure of a system for processing engineering change orders according to the invention;

FIG. 2 is a block diagram showing system structure of the system for processing engineering change orders according to the invention; and

FIG. 3 is a flow diagram showing procedural steps for performing a method for processing engineering change orders according to the invention.

### DETAILED DESCRIPTION OF PREFERRED EMBODIMENTS

In this particular embodiment, the system for processing engineering change order of the present invention is applied to the corresponding process operation flow of the related departments and personnel after an engineering design change, i.e. after an engineering change order is generated. Also, after an engineering change order is generated, the related departments and personnel include at least the engineering change order Coordinator, the departments of the Process Engineering, Material/Product Control, Quality Engineering, Testing Engineering, Product Engineering and Component Engineering, and the engineers thereof, as described above.

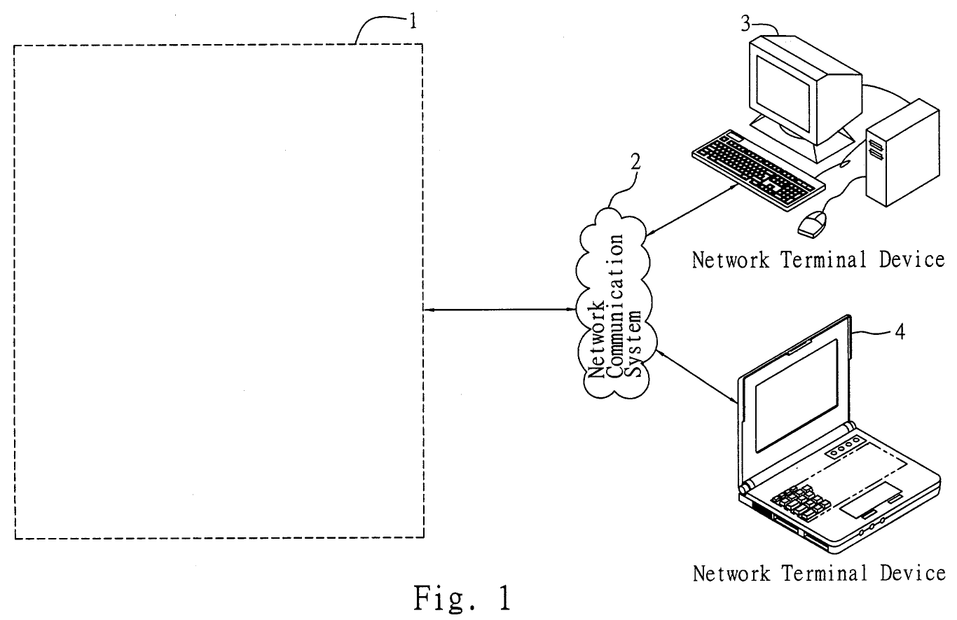

As illustrated in FIG. 1, in this particular embodiment, the system for processing engineering change order 1 of the present invention is applied in a network communication system 2 with a client-server structure. Also, the system for processing engineering change order 1 is constructed on a server end of the network communication system. The client end user of a network terminal device 3 and a network terminal device 4, that are capable of connecting with a network, may use a browser application program to connect with the system for processing engineering change order 1, constructed on the server end, through the network communication system 2, and to perform the transfer process for the data including the related data for processing the engineering change order. The network communication system 2 may be Internet, Intranet, or Extranet. The network terminal device 3 and the network terminal device 4 may be a personal computer (PC), a notebook computer (NB) or a workstation. The network application program may be the Microsoft Internet Explorer or the Netscape Navigator. The client-server structure of the network communication system 2, the network terminal device and the browser application program are well-know software and hardware structures, the discussion of which is neglected.

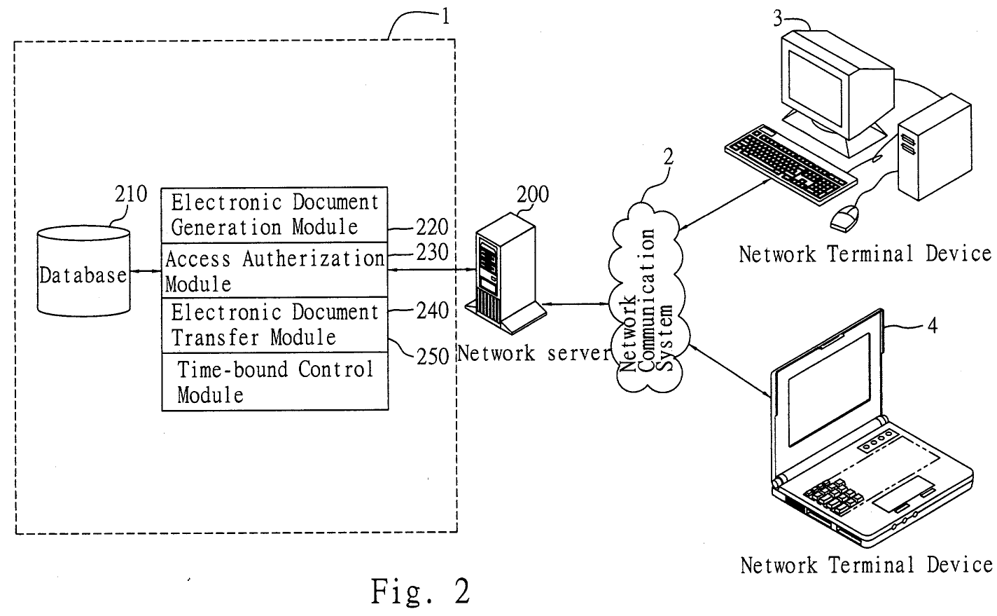

In FIG. 2, the system structure of the system for processing engineering change order 1 is illustrated. As shown in the figure, the system for processing engineering change order 1 is constructed on a network server 200. The network server 200 provides the system for processing engineering change order 1 to connect with the network terminal device 3 and the network terminal device 4 through the network communication system 2. The network server 200 also provides the network terminal device 3 and the network terminal device 4 to respond the user command or other needs and to access data. In this particular embodiment, the network terminal device 3 and the network terminal device 4 employ the network browser application program, such as the Microsoft Internet Explorer and the Netscape Navigator described above, on each of the network terminal device to connect with the system for processing engineering change order 1 via the network communication system 2 through the network server system 200, and to send, receive and access the engineering design change data and the BOM data.

The system for processing engineering change order 1 comprises of a database 210, an electronic document generation module 220, an access authorization module 230, an electronic document transfer module 240 and a time-bound control module 250.

The database 210 provides the system for processing engineering change order 1 to store at least the engineering change order data, the BOM data, the electronic document data, the engineering change order processing personnel and departments data, the access authorization data and the time-bound data, that are entered on a network terminal device through the network communication system 2. In this particular embodiment, the database 210 may be an associative database to increase the efficiency of data inquiry and searching. The engineering change order data form includes at least the data fields of the engineering design change requester, the engineering design change content, and the corresponding departments or personnel of the engineering change order after an engineering design change. The BOM data form includes at least the data fields of the name, the material number, the specification and the quantity of each of the necessary component parts of a manufactured product. The electronic document data form includes at least the data fields of the serial number and the file format of each of the electronic document. The engineering change order processing personnel and departments data form includes at least the data fields of the name, the title, the employee number, the e-mail address and the department name of each engineering change order processing engineer. The access authorization data form includes at least the data fields of processing personnel and departments corresponding to each engineering change order and the access limits in the process flow of an engineering change order. The time-bound data form includes at least the data fields of processing personnel and departments corresponding to each engineering change order and the time-bound for processing the engineering change order during the process flow of the engineering change order. By establishing such an associative database, the system for processing engineering change order 1 may rapidly find the corresponding data after a user enters any of the data described above. However, it is noted that each of the data field and the data form thereof is for exemplary purposes only, the content of which should be more specific and more in detail in practical cases. In addition, the content of each of the data field may also comprise of other data fields or data lists, however, only the data related to processing the engineering change order is shown for simplicity and clarity. On the other hand, there are also a plurality of system structures for the associative database, the establishment of which is of the prior art and the discussion of which is thus neglected.

The electronic document generation module 220 finds, from the database 210, the electronic document format data that is matching the searching criteria entered on the network terminal device, and generates an electronic document frame on the display unit of the network terminal device for a user to enter, through the input unit, e.g. keyboard or mouse, of the network terminal device, the related electronic document content for processing the desired engineering change order.

The access authorization module 230 finds the corresponding access authorization data from the database based on the data of personnel and department for processing the engineering change order, and sends, through the network communication system 2, the access authorization content to the network terminal of the processing personnel and department. Based on such access authorization content, the works of, for example, sending the Engineering Change Notification, requesting an engineering change, verifying and confirming the engineering change form or phase-in to a new date are thus implemented. Also, the access authorization information may be sent in, accompany with the electronic document of the engineering change order, or as an independent electronic document format, to the network terminal device of the processing personnel and departments. It may be modified and customized depending on the user needs.

The electronic document transfer module 240 finds, from the database 210, the personnel and department data for processing the engineering change order that is matching the electronic document content entered on the input unit of the network terminal device, and transfers and receives the electronic document. In this particular embodiment, according to the engineering change order processing personnel and department data entered by the user and the default transfer sequence, if the electronic document format includes the data, entered by a user, of related engineering change order processing personnel and department, then the electronic document transfer module 240 finds, from the database 210, the data of the engineering change order processing personnel and department, e.g. e-mail address, and implements the transfer process accordingly.

The time-bound control module 250 implements a time-bound control, based on the default time-bound of operation flow, during the transfer process of electronic document by the electronic document transfer module 240. In this particular embodiment, the electronic document transfer module 240 sends the electronic document of an engineering change order to the related engineering change order processing personnel and departments, and implements the process of approving the engineering design change by the engineering change order processing personnel and departments. In the approval process of engineering change order, each engineering change order personnel and department has a reasonable decision deadline, any modification or confirmation of the engineering change order must be completed prior to the deadline. Once the reasonable deadline is past, enterprises will pay even larger costs. Therefore, by using the time-bound control module 250, the deadline of each of the engineering change order processing personnel and department may then be under control. In addition, the time-bound control module 250 may also notify the related engineering change order processing personnel and departments, before or after the deadline, by sending out an e-mail, or in other fashion, to take accordingly some proper actions.

The steps for implementing the method for processing engineering change order on the above-mentioned system for processing the engineering change order 1 are described in the following.

First, the electronic document generation module 220 finds the engineering change order data from the database 210 according the searching criteria entered by a user on the network terminal device and generates accordingly an electronic document file of the engineering change order. In this particular embodiment, if the user wishes to implement a notification and transfer of engineering change order on the network terminal device through the network communication system 2, the user may enter some specific or any searching criteria or searching condition via the network terminal device. After the electronic document generation module 220 has received the searching criteria or searching condition entered by the user, the corresponding electronic document file of the engineering change order is then found from the database 210.

Then, the access authorization module 230 finds, from the database 210, the corresponding access authorization content based on the department and access limits of the owner of the engineering change order such that the owner may proceed the implementation process. As described above, in this particular embodiment, if the engineering change order is the first issue sent by the engineering change order coordinator, then the owner of the electronic file of the engineering change order is the engineering change order coordinator. At the mean time, the access authorization module 230 finds the corresponding access limits of the engineering change order coordinator from the database 210, wherein the access limits may be, for example, the phase-in notification, the engineering change order phase-in action notice and the first issue of the engineering change order. Instead of sending access limits in accompany with the electronic document of the engineering change order to the engineering change order coordinator, as described above, the access authorization module 230 may also send the access limits, by an independent electronic document, e.g. by an e-mail, to the network terminal device of the processing personnel and department. It may also be modified and customized depending on the user needs.

Next, the electronic document transfer module 240 sends and receives the engineering change order based on the content of the engineering change order and the access limits. As described above, in this particular embodiment, the engineering change order coordinator decides the modification, verification or confirmation of the content of the engineering change order to be implemented by the related departments and personnel including the departments of Process Engineering, Material/Product Control, Quality Engineering, Testing Engineering, Product Engineering and Component Engineering, and the engineers thereof. The engineering change order coordinator then enters the related processing personnel and departments described above in the engineering change order on the network device. When the engineering change order coordinator wishes to transfer the engineering change order, the electronic document transfer module 240 will find, from the database 210, the related data, e.g. the e-mail address, of the processing personnel and departments matching that entered as described above to transfer the engineering change order according to the e-mail address or other data. On the other hand, the electronic document transfer module 240 may also transfer the engineering change order according to the engineering change order transfer sequence preset by the engineering change order coordinator.

Finally, the time-bound control module 250 controls and monitors, in real-time, the process time-bound of the engineering change order owner while the electronic document transfer module 250 is transferring the engineering change order. In this particular embodiment, there is a reasonable time-bound for each transfer or processing flow of the engineering change order between different flow steps or between different processing personnel and departments. If the time-bound of the first issue of engineering change order that is sent by the engineering change order coordinator is one working day, the time-bound control module 250 then starts counting the time when the engineering change order coordinator generates the electronic document of the engineering change order. Once the time-bound is exceeded, the time-bound control module 250 then sends out a notification e-mail to the related personnel and departments for processing the engineering change order. The processing personnel and department may thus control the progress of and take proper response to the processing of engineering change order at any time.

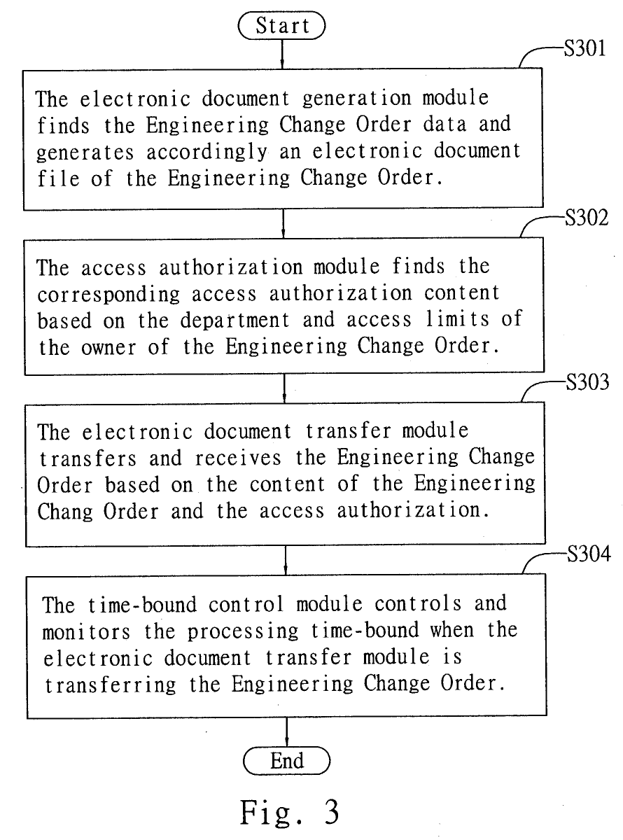

In FIG. 3, the flow steps of a method for processing engineering change order of the present invention is illustrated. The system for processing engineering change order 1 is constructed on a network server 200, which provides the system for processing engineering change order 1 to connect with the network terminal device through the network communication system 2, and which provides the network terminal device to respond the user command or other needs and to access data. Furthermore, a database 210 is also constructed to store at least the engineering change order data, the BOM data, the electronic document data, the engineering change order processing personnel and departments data, the access authorization data and the time-bound data, then proceed to step S301.

In step S301, the electronic document generation module 220 finds, from the database 210, the engineering change order data based on the searching criteria entered by a user on the network terminal device, and generates accordingly an electronic document file of the Engineering Change Data, then proceed to step S302.

In step S302, the access authorization module 230 finds, from the database 210, the corresponding access authorization content based on the department and the access limits of the owner of the engineering change order to implement by a user, then proceed to step S303.

In step S303, the electronic file transfer module 240 transfers and receives the engineering change order according to the engineering change order and the access authorization content, then proceed to step S304.

In step S304, the time-bound control module 250 controls and monitors, in real-time, the processing time-bound of the owner of the engineering Change Order when the electronic document transfer module 240 is transferring the engineering Change Order.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for processing engineering change orders for allowing a user to control processing flow of an engineering change order via a network terminal device and a network communication system, with processed data of the engineering change order being stored in a database, the method comprising the steps of:
having an electronic document generation module search engineering change order data from the database according to search conditions entered by the user via the network terminal device and accordingly generate an engineering change order in the form of an electronic document file;
having an access authorization module find associated responsible departments and access rights thereof from the database corresponding to the engineering change order;
having an electronic document transfer module transfer the engineering change order to the responsible departments where data of the engineering change order are processed according to the access rights of the responsible departments, and receive the processed data of the engineering change order from the responsible departments; and
having a time-bound control module monitor and control in real time working efficiency of the responsible departments for processing the engineering change order according to default time-bound settings predetermined by the user during the process of transferring and receiving the engineering change order via the electronic document transfer module.

2. The method of claim 1, wherein the network terminal device is a workstation, personal computer, notebook computer, palm computer, personal digital assistant (PDA), or mobile phone.

3. The method of claim 1, wherein the network communication system is Internet, Intranet, or Extranet.

4. The method of claim 1, wherein the network communication system is a wireless or cable communication system.

5. The method of claim 1, wherein the database is an associative database.

6. A system for processing engineering change orders for allowing a user to control processing flow of an engineering change order via a network terminal device and a network communication system, the system comprising:
a database for storing engineering change order data entered by the user via the network terminal device and the network communication system;
an electronic document generation module for searching engineering change order data from the database according to search conditions entered by the user via the network terminal device and accordingly generating an engineering change order in the form of an electronic document file;
an access authorization module for finding associated responsible departments and access rights thereof from the database corresponding to the engineering change order;
an electronic document transfer module for transferring the engineering change order to the responsible departments where data of the engineering change order are processed according to the access rights of the responsible departments and for receiving the processed data of the engineering change order from the responsible departments; and
a time-bound control module for monitoring and controlling working efficiency of the responsible departments for processing the engineering change order according to default time-bound settings predetermined by the user when the engineering change order is transferred and received by the electronic document transfer module.

7. The system of claim 6, wherein the network terminal device is a workstation, personal computer, notebook computer, palm computer, personal digital assistant (PDA), or mobile phone.

8. The system of claim 6, wherein the network communication system is Internet, Intranet, or Extranet.

9. The system of claim 6, wherein the network communication system is a wireless or cable communication system.

10. The system of claim 6, wherein the database is an associative database.
